(19) United States
(12) Patent Application Publication
(10) Pub. No.: US 2010/0086633 A1
(43) Pub. Date: Apr. 8, 2010

(54) DUAL ROLLER ASSEMBLY WITH EJECTION MECHANISM FOR FOOD-FORMING MACHINE

(76) Inventor: Robert OU-YOUNG, Chung-Ho City (TW)

Correspondence Address: Guice Patents PLLC, 12647 Galveston Court #302, Manassas, VA, 20112, US

(21) Appl. No.: 12/245,783

(22) Filed: Oct. 6, 2008

(51) Int. Cl. A21C 3/02

(52) U.S. Cl. 425/335

(57) ABSTRACT

A dual roller assembly with an ejection mechanism for a food-forming machine serves to make stuffed food pieces. The dual roller assembly is characterized in that one or more rows of equidistant mold cavities are arranged at peripheries of a pair of corresponding forming rollers thereof, wherein each of the mold cavities is equipped with a propping block moved by a cam so that the formed food pieces be ejected from the mold cavities by the propping block smoothly.

### BACKGROUND OF THE INVENTION

1. Technical Field

The present invention relates to a roller assembly for a food-forming machine, wherein a propping block capable of reciprocating is provided in each mold cavity of the roller assembly for facilitating ejecting formed food pieces from the mold cavity.

2. Description of Related Art

The generally known “formed food” relates to food products formed by shaping dough sheets with mold cavities of various shapes or with molding rollers having mold cavities, or treating moving dough sheets with reciprocating molds so as to form the dough sheet into food pieces of various shapes.

The so-called “forming food technology” refers to a molding process that shapes food into three-dimensional shapes such as a round shape, an elliptic shape, a heart shape, a scallop shape, a fish shape, an elephant shape and a leaf shape. More particularly, the molding process involves forming pliable flour dough or flour paste composed of flour, water and seasonings into food products with desired shapes, wherein the flour dough may receive repeated rolling and kneading procedures so as to endow the food products with an elastic texture. Herein, the formed food products may be divided into unstuffed food pieces and stuffed food pieces.

The food products may include single-side raised shape and dual-side raised shape. To clarify, the single-side raised shape, also known as the hemispheric shape, is derived form a vertically or horizontally symmetrical mold pair that only has one mold thereof provided with cavities of predetermined shapes; while the dual-side raised shape, also known as the spherical shape, is made through a mold pair composed of molds with facing mold cavities.

Both the molds form the single-side and dual-side raised shapes by being clamped together to press the material dough therein. Since the formed food pieces typically have viscidity to some extent, after the clamped molds are opened to release the formed food pieces, some of the formed food pieces may adhere to the mold and not depart from the mold merely by the force of gravity, thereby causing inconvenience to the manufacturer.

In view of the aforementioned problems, some solutions have been developed by manufacturers:
1. Periodically applying flour on surfaces of the mold cavities manually or mechanically so as to prevent the formed food pieces from adhering to the surfaces of the mold cavities;
2. Equipping scrapers at a place where the molds are opened so as to scrape the formed food pieces from the mold cavities;
3. Equipping air nozzles at a place where the molds are opened so as to blow the formed food pieces away from the mold cavities; and
4. Equipping oil pads or brushes at a place where the molds are opened so as to apply oil onto surfaces of the mold cavities.

While these approaches may be effective in preventing the formed food pieces from adhering to the surfaces of the mold cavities, they also bring adverse effects such as adding additional complexity to the mold assembly, leaving the formed food pieces with scrapping scars, and over oiling the food pieces, and thus need to be replaced with an improved solution.

### SUMMARY OF THE INVENTION

In view of the aforementioned need, the present invention provides a dual roller assembly with an ejection mechanism for a food-forming machine. The disclosed dual roller assembly effectively remedies the problem of the traditional devices where formed food pieces tend to adhere to mold cavities and hence technically contributes to the industry.

According to the present invention, the dual roller assembly with the ejection mechanism helps to eject formed food pieces from mold cavities on the dual roller assembly. To achieve this effect, one or more rows of equidistant mold cavities are arranged at peripheries of a pair of forming rollers corresponding to each other, wherein each of the mold cavities is equipped with a propping block moved by a cam so that food pieces formed from a dough sheet by the mold cavities can be then ejected from the mold cavities smoothly by the propping blocks.

### BRIEF DESCRIPTION OF THE DRAWINGS

The invention, as well as a preferred mode of use, further objectives and advantages thereof, will be best understood by reference to the following detailed description of illustrative embodiments when read in conjunction with the accompanying drawings, wherein:

FIG. 1 is an exploded view of a dual roller assembly of the present invention;

FIG. 2 is a side view of the dual roller assembly of the present invention;

FIG. 3 is a side view of one roller of the dual roller assembly of the present invention;

FIG. 4 is a cross-sectional view of the roller of the dual roller assembly of the present invention;

FIG. 5 is a schematic drawing showing operation of the dual roller assembly of the present invention;

FIG. 6 provides an alternative embodiment of the present invention wherein the dual roller assembly has only one said roller formed with mold cavities; and

FIG. 7 is a lateral view of the dual roller assembly of FIG. 6.

### DETAILED DESCRIPTION OF THE PREFERRED EMBODIMENTS

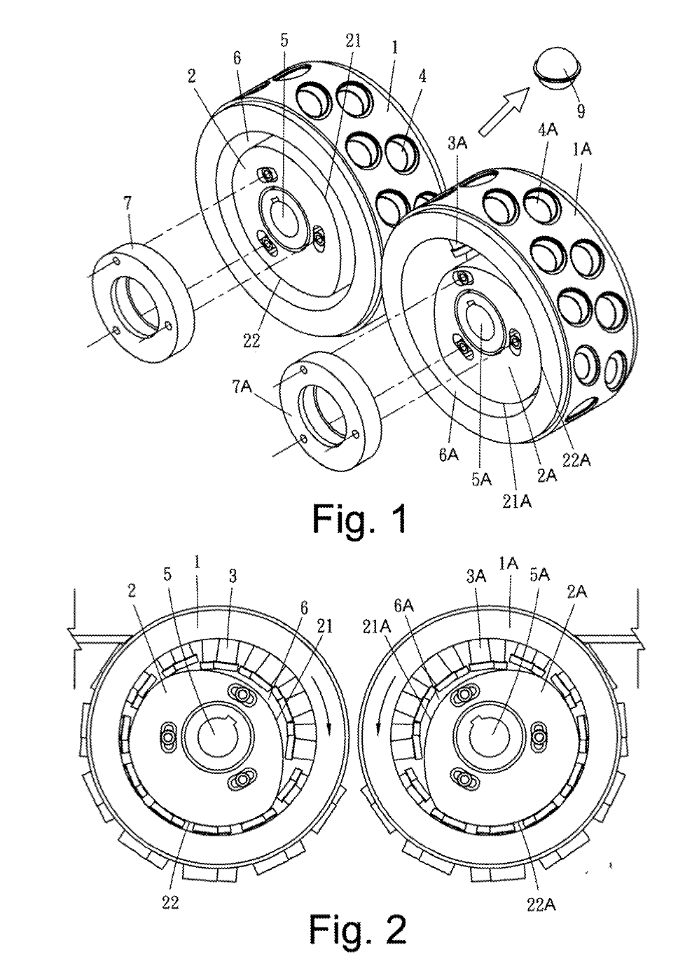

Please refer to FIGS. 1 and 2 for one embodiment of a dual roller assembly with an ejection mechanism according to the present invention. The dual roller assembly primarily comprises a pair of forming rollers 1, 1A adjacently and abreast, cams 2, 2A arranged in central spaces 6, 6A of the forming rollers 1, 1A, respectively, and a plurality of propping blocks 3, 3A.

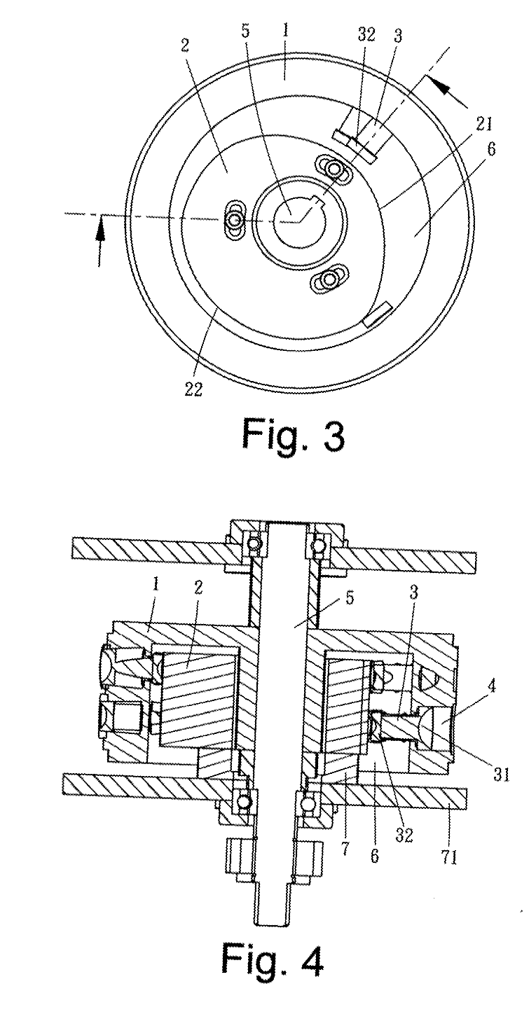

As can be seen in FIGS. 3 and 4, the forming rollers 1, 1A abut against each other and are driven to roll in counter directions by shafts 5, 5A, respectively. Each said forming roller 1 or 1A has the central space 6 or 6A and formed at an outer periphery thereof with one or more rows of mold cavities 4 or 4A. Moreover, each said mold cavity 4 or 4A is provided therein with one said propping block 3 or 3A that is driven by the corresponding cam 2 or 2A to move upward or downward linearly in the mold cavity 4 or 4A.

Seeing FIG. 4, the description is now directed to one said forming roller 1. Each said propping block 3 has one end in the corresponding mold cavity 4 formed with a basin 31 and another end extending into the central space 6 of the forming roller 1 formed with a flange 32.

In the present embodiment, the cams 2, 2A are symmetrically fixed with predetermined angles to a fixing board 71 of the food-forming machine settled beside the forming rollers 1, 1A by means of metal rings 7, 7A, respectively.

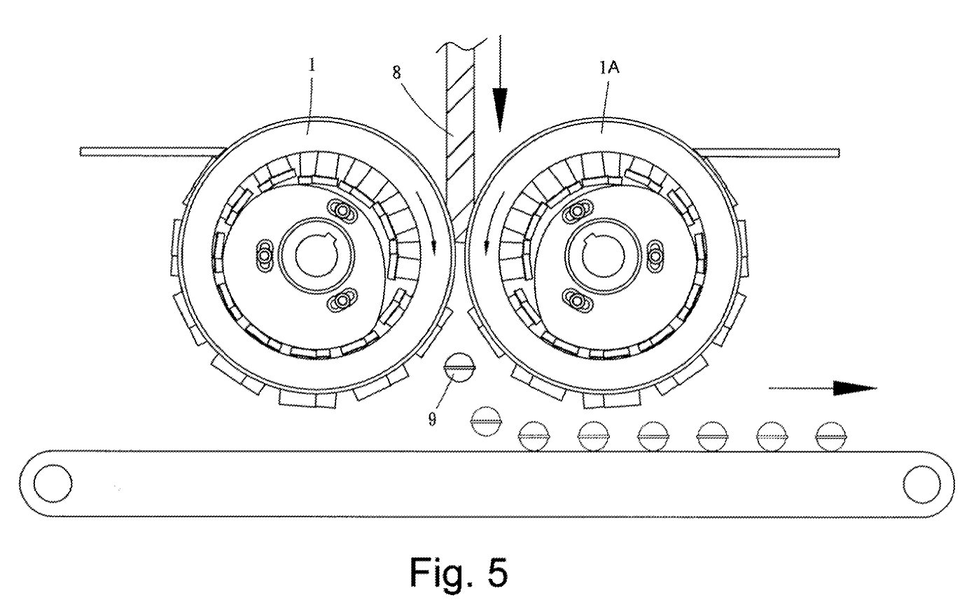

Reference is now made to FIG. 5. In operation of the subject matter of the present invention, a dough sheet 8 to be formed, whether with or without stuffing therein, is delivered to pass between the forming rollers 1, 1A, so that when the forming rollers 1, 1A run in the counter directions, the dough sheet 8 is drawn downward and shaped between the mold cavities 4, 4A so as to form food pieces 9 of a dual-side raised shape. At this time, the propping blocks 3, 3A are positionally corresponding to concaves 21, 21A of the cams 2, 2A and thus retract into the central spaces 6, 6A of the forming rollers 1, 1A.

Then, the forming rollers 1, 1A keep running and bring the formed food pieces 9 to a place where the mold cavities 4, 4A depart from each other, At this time, the flanges 32 at the ends of the propping blocks 3, 3A touch convexes 22, 22A of the cams 2, 2A and thus jut out the peripheries of the forming rollers 1, 1A. In other words, a depth where the propping blocks 3, 3A retract into the peripheries of the forming rollers 1, 1A and a travel length where the propping blocks 3, 3A jut out the peripheries of the forming rollers 1, 1A are determined by designs of the concaves 21, 21A and convexes 22, 22A of the cams 2, 2A.

Thereby, the formed food pieces 9 can be smoothly and completely ejected form the mold cavities 4, 4A without a need of additionally applying flour or oil on the mold cavities 4, 4A.

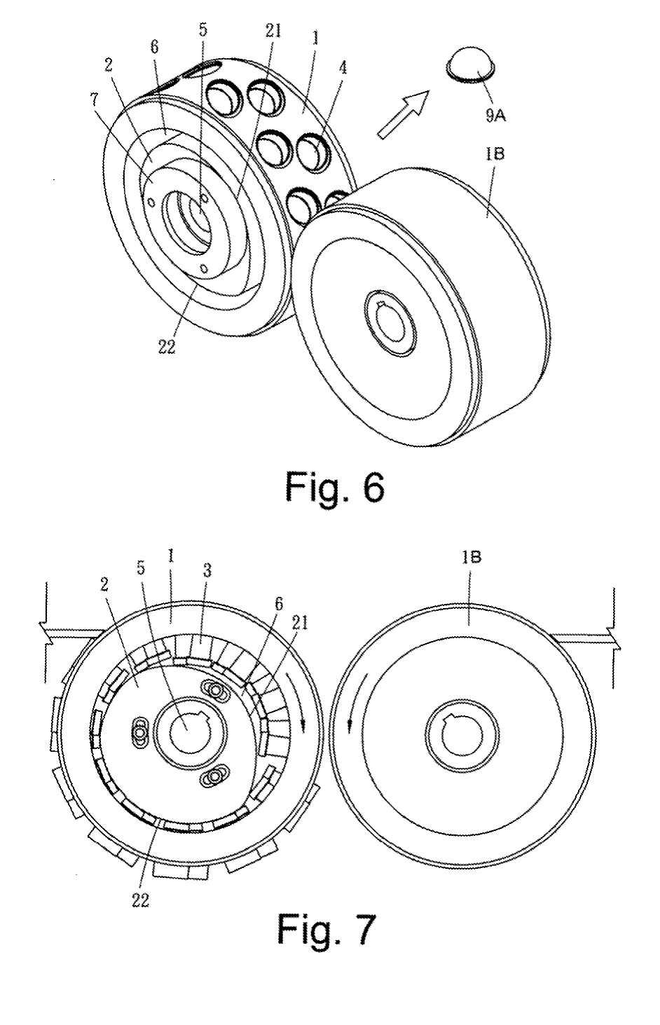

An alternative embodiment of the present invention is depicted in FIGS. 6 and 7. In the present embodiment, only a forming roller 1 of the dual roller assembly is provided with mold cavities 4 while the forming roller 1A of the previous described embodiment is replaced in the present embodiment by a roller 1B having its periphery formed as a smooth surface without any said mold cavity 4A thereon so as to make food pieces of a single-side raised shape 9A.

1-2. (canceled)

3. The dual roller assembly of claim 8, wherein the mold cavities on the corresponding forming rollers serve to press and form a dough sheet into food pieces of a dual-side raised shape when the forming rollers run in the counter directions.

4. The dual roller assembly of claim 8, wherein after the forming rollers form a dough sheet into food pieces of a dual-side raised shape and bring the formed food pieces to a place where the mold cavities depart from each other, flanges at ends of the propping blocks touch convexes of the cams and thus jut out the peripheries of the forming rollers so as to eject the formed food pieces from the mold cavities.

5. The dual roller assembly of claim 8, wherein the cams in the two forming rollers are fixed counter in shapes thereof.

6. The dual roller assembly of claim 8, wherein a depth where the propping blocks retract into the peripheries of the forming rollers and a travel length where the propping blocks jut out the peripheries of the forming rollers are determined by designs of concaves and convexes of the cams.

7. The dual roller assembly of claim 8, wherein only one of the forming rollers is provided with the mold cavities and the other forming roller has the periphery thereof without any mold cavity so as to make food pieces of a single-side raised shape.

8. A dual roller assembly with an ejection mechanism for a food-forming machine, said dual roller assembly comprising:
a pair of forming rollers corresponding to and abutting against each other, each of the pair of forming rollers being connected to a shaft, said pair of forming rollers being driven to roll in opposite directions;
at least one forming roller of the pair of forming rollers has a cam located in a central space thereof, at least one row of mold cavities formed in an outer periphery located around the central space, and a plurality of propping blocks, each mold cavity of said at least one row of mold cavities communicating with the central space and the outer periphery of the at least one forming roller, each mold cavity of said at least one row of mold cavities has a corresponding propping block of the plurality of propping blocks located therein;
each corresponding propping block of the plurality of propping blocks has a basin located on a first end thereof and a flange located on a second end thereof, the basin of each corresponding propping block is located in a corresponding mold cavity and the flange of each corresponding propping block is located in the central space of a corresponding one of said pair of forming rollers;
the basin of each corresponding propping block is movable radially along the mold cavity between a first position located adjacent to an outer end of the mold cavity and a second position located within the mold cavity and spaced apart from the outer end of the mold cavity; and
said cam being symmetrically fixed at a predetermined angle relative to a fixing board of the food-forming machine located adjacent to the forming rollers.

9. The dual roller assembly of claim 1, wherein each of the pair of forming rollers has a cam located in a central space thereof, at least one row of mold cavities formed in an outer periphery located around the central space, and a plurality of propping blocks.
